(19) United States
(12) Patent Application Publication
(10) Pub. No.: US 2005/0086607 A1
(43) Pub. Date: Apr. 21, 2005

(54) Sound and/or visual signal processing disposition applicable to electronic devices that run operating systems and method for executing this disposition

(76) Inventor: Guillermo Daniel Tyberg, Provincia de Buenos Aires (AR)

Correspondence Address: NORRIS, MCLAUGHLIN & MARCUS, P.A., 875 THIRD AVE, 18TH FLOOR, NEW YORK, NY, 10022, US

(21) Appl. No.: 10/965,029

(22) Filed: Oct. 14, 2004

(30) Foreign Application Priority Data
Oct. 16, 2003 (AR) P 030103779

(51) Int. Cl. G06F 9/00; G06F 3/00; G06F 13/00; G06F 9/44; G06F 17/00; G06F 9/46; G06F 15/16

(52) U.S. Cl. 715/760; 719/330; 709/201

(57) ABSTRACT

A sound and/or visual signals processing disposition applicable to electronic devices that run operating systems and method for executing this disposition. These electronic devices can be on idle or can be connected to a network. The disposition comprises a module which is called by a program, said module runs at least one routine, defining said at least one routine a zone of interaction with a user. The disposition can be used in computer announcing systems, TV systems, or any electronic device capable of executing audiovisual signals. Said announcing systems can be on-line and off-line advertising, internal or external corporative announces, task helpers or user graphic interfaces.

### BACKGROUND OF THE INVENTION

1. Field of the Invention

The present invention refers to a sound and/or visual signals processing disposition applicable to electronic devices that run operating systems and method for executing this disposition, being said audio-visual means disposition executed on electronic devices, which can be connected or not connected to a network.

2. Description of the Related Art

It is well known that Internet has become into an information source for the consumer making a better purchasing decision, being this in the traditional way or on-line. Hence publicity in Internet offers added values, being used as support means for traditional campaigns or as an independent way of publicity. In spite of the advertising investment reduction that has been befallen lately, a maintained growth and a biggest market is anticipated for the following years all around the world. Relating to this topic, budgets for Internet advertising of companies and publicity agencies are still very small, but it has been registered a slow but continuous growth.

On the other hand, it is true that nowadays millions of computers users do not want to pay for software they use. As a result of this reality, independent programmers and small and medium software developing companies have been urged to look for new ways for generating profits and financing their products.

As a solution, the companies have thought the following thing: even though it is true that user is not willing to pay for the software he uses, it would be possible that the user did not have to pay for the use of the program if he accepts receiving selective publicity while using the program. This way, the software companies obtain large profits that are absolutely unthinkable in another context.

It is known that there are diverse modalities for advertising on a computer. On one hand it is possible to use the advertising method called “banners”. Banners are fixed rectangular advertisements that are displayed when user enters on a web page. As a result of its tested inefficiency, banners are being gradually replaced by “flash-ads”. This kind of publicity is made up of interactive animations that look that the banners. “Flash-ads” are also executed in the window generated by the Internet navigator (for example: Internet Explorer (®), Netscape(®), Mozilla(®), Opera(®) and the similar) and include sound effects, which are short enough. It is possible to emphasize that this modality is much more effective that banners are, by the simple fact of being something different that the well-known and because these type of advertisements “float” on navigator window, thus being the advertising capable to be visualized anywhere in the window and to move within the limits of the navigator window.

Additionally, it is important to mention another type of advertising that does not generally depend on that the computer in which it is displayed has to be connected to a network as Internet. In fact, desktop applications generally distributed as free programs (shareware, freeware and the similar), give the possibility to the company to offer free or proof versions facing the cost by means of publicity, advertising within the section where the program is visualized or opening another window showing some advertising. This type of publicity is stored on said program or on a file generated during its installation process. It is possible to emphasize that this kind of advertising can be updated every time the computer is connected to Internet.

Unfortunately, desktop applications based on the present technology can only show banners and/or flash-ads in some pre-established sector of the screen, it is to say being the advertising displayed within the context of a window, being this windows the same window of the program or one that has been specially generated for the program in order to show the advertising. Unfortunately, this type of publicity method is not very effective since the user is who has control on the window/s generated for the advertisement, so the user can stop or close the window generated by the program, resulting in that the message intended to be transmitted is not completely received.

### SUMMARY OF THE INVENTION

It is therefore an object of the invention to provide an audio-visual disposition applicable to computers that run operating systems with a user graphic interface capable to show flash-ads advertisements out of the banner outside the announcement, including and/or using background transparency in any program and/or operating system without concerning their design, sound or interaction.

It is still another object of the present invention to provide a sound and/or visual signals processing disposition applicable to electronic devices that run operating systems being these devices connected or not connected to a network, to offer a new and polymorphic way for interacting with the user, beyond the normal context of the rectangular structure of the operating systems.

It is a further object of the present invention to provide a sound and/or visual signals processing disposition applicable to electronic devices that run operating systems being these connected or not connected to a network, wherein the disposition comprises a module which is called by a program, said module runs at least one routine, defining said at least one routine an interaction-with-the-user zone.

### BRIEF DESCRIPTION OF THE DRAWINGS

The present invention is illustrated by way of example in the following drawings wherein:

FIG. 1 is a flow chart that shows the internal operation of the disposition object of the present invention.

FIG. 2 is a flow chart that shows the internal operation of an alternative embodiment of the disposition object of the present invention.

FIG. 3 is a diagram that shows an application of the disposition object of the present invention.

FIG. 4 is a diagram of another embodiment of the application of the disposition object of the present invention.

FIG. 5 is a diagram of still another embodiment of the application of the disposition object of the present invention.

### DETAILED DESCRIPTION OF THE PREFERRED EMBODIMENTS

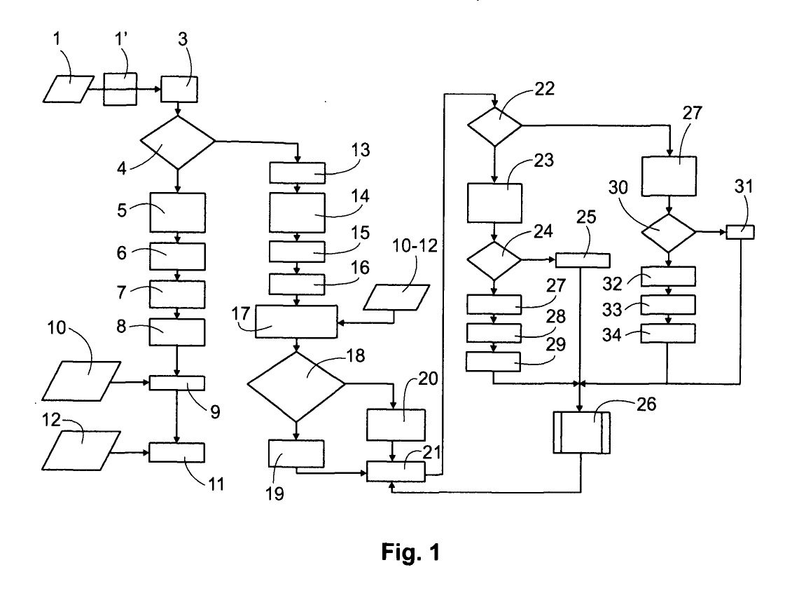

Reference is now made to FIG. 1 of the drawings, which comprises a flow chart that shows the internal operation of the disposition object of the present invention. The audio-visual disposition object of the present invention mainly comprises a module. It is possible to mention that this module can be, for example, a program unit, a DLL file (Dynamic Link Library), a SO file (Shared Object), or the similar, whenever it fulfills the purpose described in the present invention. A program runs said module, being this program a host program of said module. This module runs at least a routine that defines at least a zone of interaction with a user. It is possible to emphasize that said zone of interaction with the user of the computer might be defined by an area placed inside, outside or inside and outside a window, being this window generated by the host program.

The disposition of the present invention is not limited to the operating system that commands the electronic device, being this disposition able to be applied in electronic devices that run diverse operating systems such as Windows (®) (in all its versions), Linux (in all its versions), TRON (The Real-Time Operating System Nucleus), operating system used in most of the electronic devices, MacOS (apple macintosh), and the similar.

As it has been mentioned before, FIG. 1 shows the internal operation of the disposition object of the present invention. In fact, the method for executing the disposition starts as described a afterwards: Before displaying the advertisement, module 1 detects (step 3) how capable the operating system is for executing said module correctly. It is possible to emphasize that a step 1′ can be alternatively implemented, wherein the disposition reports the user that it is being executed. Of course, step 1′ can be interactive with the user.

Subsequently, at step 4 it is verified whether the operating system includes layered window attributes and/or alpha channel graphics attributes. In that case, in step 5 an invisible FORM is created by means of a renderer. This renderer software can be an own renderer or may belong to a third; anyway, it will be simply called “renderer” from now on, unless it would be necessary clarifying who said software belongs to. As everybody skilled in the art knows, word “renderer” is used to define those programs used to take certain data and to generate a result as, static and/or dynamic images, sound and/or the combination of images and sounds (these programs can be, for instance, animation programs, mathematical function plotting programs, and the similar).

Afterward, FORM is assigned the layered window attributes and/or alpha channel graphics attributes in step 6. In step 7 the properties of the FORM are set while in step 8 a multimedia file or a stream of data is assigned to the renderer. The FORM is shown in step 9, and alternatively, in step 10 events that must be hidden, which are called as process A, are hidden. After this, the rendering is started in step 11 and the audiovisual disposition is executed, being the disposition a visual or audio advertisement, an informative message, or the similar. Simultaneously, at step 12 the interaction of the user with the advertisement is intercepted or commands denominated as process B are rendering.

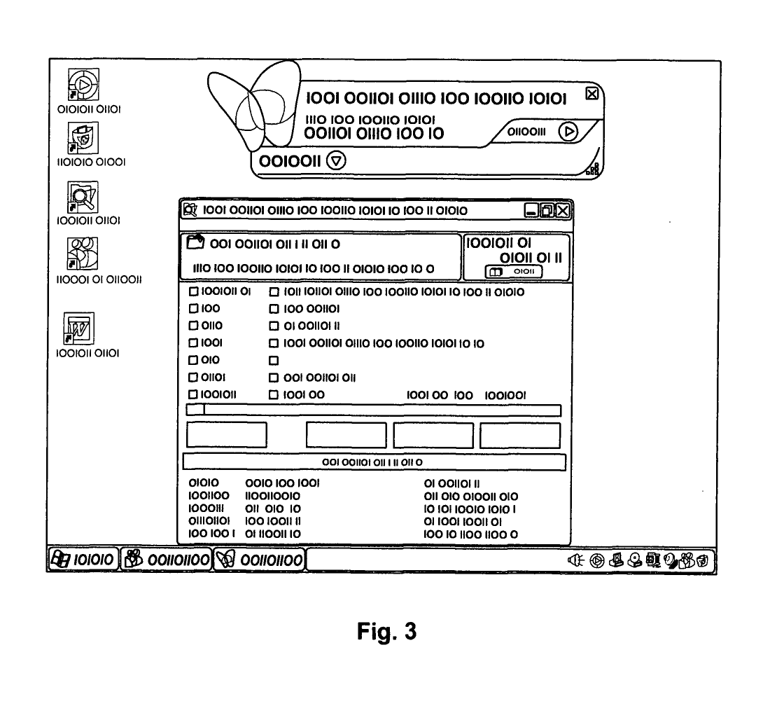

In the case that as a result of the checking of step 4 it would have been verified that the operative system does not include layered window attributes and/or alpha channel graphics attributes, so a void variable BMP_TEMP is generated at step 13. Then, an invisible FORM by means of a renderer is created at step 14, and at step 15 a value is assigned to variable NRO. Later, at step 16 it is created a B1 variable of empty region. At step 17 a multimedia file or a stream of data is assigned to the renderer and B1 is assigned to FORM. After that, FORM is displayed and the execution/rendering is started. Alternatively, as shown in FIG. 3, steps 10 and 12 can be applied to step 17 can be applied.

At step 18 it is verified if the renderer includes displaying device context exportation functions (DC). If this is thus, said context exportation functions are used when a renderer.DC variable at step 19 is needed. In case those functions are not included in the renderer, at step 20 when needing renderer.DC variable, pictures are captured from form.dc-area. Later, after steps 19 and 20, at step 21, the value of rendering.DC is assigned to BMP_TEMP. Then, at step 22, it is verified if variable NRO is equal to 1. In that case, at step 23 B1 is reset taking as mask the picture stored on BMP_TEMP without background. Then, at step 24 whether B1 is equal to B2 is checked. In that case, B1 is cleared at step 25, and if it is necessary, FORM is redrawn at step 26 and the logic of the disposition returns to step 21.

If at step 24, B1 is not equal to B2, at step 27 B1 is assigned to FORM; then, at step 28 the value of B2 is eliminated and at step 29 variable NRO is loaded with value 2. After this, the disposition returns to step 26. If at step 22 variable NRO is not equal to 1, then the disposition jumps to step 27 in order to reset B2, using as mask the picture stored in variable BMP_TEMP without the background. Then, at step it is verified if B1 is equal to B2. If they are equal, at step 31 the value of B2 is eliminated, proceeding to step 26.

In case that 30 being negative, the flow chart continues at step 32 and B2 is assigned to FORM, then at step 33 the value of B1 is deleted, while at step 32 variable NRO is loaded with 1. After that the disposition jumps to step 26. It is possible to emphasize that this is just an example of execution of the disposition object of the present invention, and as any person known in the matter will be able to interpret, endless variations and modifications are into the scope of invention.

Having explained at least one of the routines that module 1 of the audio-visual disposition object of the present invention is able to do, now, some of the alternatives of the audio-visual disposition will be explained.

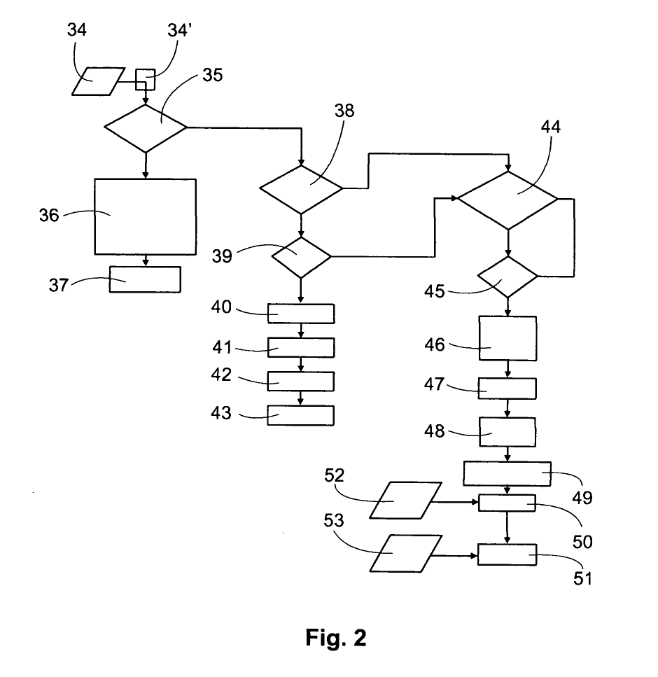

Referring now to FIG. 2, it shows an embodiment of a method for executing said disposition. Indeed, this method is used to reduce the tasks executed by the disposition using tools provided by the renderer, such as displaying the disposition on screen or reproducing sounds. As shown in FIG. 2, the method stars booting the module at step 34. Later, at step 35 it is asked if distributed rendering services are desired to be used, in that case, at step 36 configuration data are sent. These data include attributes allocation, the multimedia file or a stream of data allocation and the configuration of the background color. Then, at step 37, the advertisement starting order is sent. It is possible to emphasize that a step 34′, wherein the disposition reports the user that said disposition is being executed, can be alternatively implemented. As it has been previously mentioned, said step 34′ can include the interaction with the user.

In case the step 35 being negative, the method jumps to step 38 wherein it is asked if the renderer is able to create a windows-form (“classic window”, which is a platform for developing graphical applications (®)). If the result of step 38 is affirmative, at step 39 it is asked if said capability is desired to be used. In that case, properties of FORM.renderizer are set at step 40. Then, at step 41, the multimedia file or a stream of data is assigned to the renderer, and the order for displaying the FORM is sent later. Then, at step 43, the rendering is started and executed.

If steps 38 or 39 are false, the disposition jumps to the step 44 where it is enquired if the renderer can deal with transparent backgrounds, if the answer is “true”, at step 45 it is asked if this capability is going to be used. An invisible FORM, by means of a renderer, is created at step 46 if the result of the step 45 is “true”. Later, properties are assigned to the FORM at step 47, and at step 48 the multimedia files or the streams of data are assigned to the renderer. Then, a value corresponding to the background color is assigned to renderer.transparent at step 49 and the FORM is displayed at step 50. Simultaneously, at step 52 it is verified if there are events that has to be hidden (such as running order, time, etc.). At step 51 the rendering is started and executed. Additionally, at step 53, interactions with the user, like specific commands or messages, are processed. In case the results of steps 44 and 45 were “false”, the routine will engage with step 3 and will carry on running. It is important to emphasize that the term “assigning a multimedia file or a stream of data”, which has been several times previously mentioned, has to be understood widely, since it refers both to the physical location of a file and to the assignation of the file data (data stream).

Even though the present invention is preferably destined to show advertisements, said advertisement con belong to a group comprising publicity advertisement, informative notes, instantaneous messages, and the combination of them, being the kind of advertisement not limitative of the scope of the invention.

For better understanding the present invention and referring to FIG. 3, it will now be explained the operation of the audio-visual disposition.

In effect, when a user uses a free program, for example Winamp ® (version free www.winamp.com), the owner of said host program can incorporate in its code the module of the disposition of the present invention. According to how the owner sets the module settings, which can assigned by the programmer of the module or can be customized according to the requirements of the host program, when the user runs said program (for example: Winamp (®) an advertisement is displayed on screen, as shown in FIG. 3. This advertisement is designed with flash technology (www.macromedia.com). As it is well known, this technology allows making any kind of picture animations. It is important to emphasize that even though in this particular accomplishment the audio-visual disposition module has used the render engine included in Flash, this engine can be replaced by any other rendering engine, being said engine a commercially available one or a customized engine, which can even be included in the module. This last option is important because the module could be executed no matter if the computer where the host program is running has or does not have a renderer.

Referring now to FIG. 3, in this alternative accomplishment the user's computer is running a program (AOL®). In this case, the publicity advertisement comes into view from “outside” the screen. It is possible to emphasize that in this particular case the disposition is set to be run more than once during the period of time the user has the host program running. Of course, it is possible to configure a disposition for more than a host program, wherein if several host programs are run simultaneously, it is possible that more than an advertisement being or not shown.

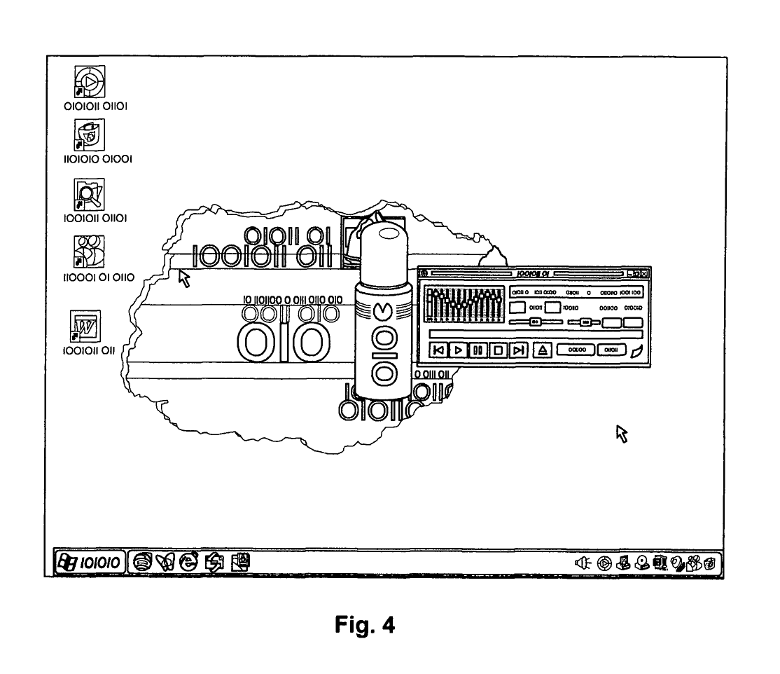

Referring now to FIG. 4, in this alternative of accomplishment the user executes a program wherein the advertisement is shown outside the screen area in use by the program window. The user can interact with the advertisement in this embodiment, in order to obtain information related to the advertisement, for instance, doing “click” on the advertisement; or to close it in case the user does not want to keep on watching the advertisement on screen. It is possible to emphasize, that according to the configuration of the module, the advertisement can be shown permanently or be closed automatically, or even the module can run a displaying cycle according to the tasks the computer is doing (screensaver, mouse movement, etc.).

The disposition object of the present invention has been developed for any kind of host programs such as Shareware, Trialware, Donationware, Demos, and others, it can also be used on programs with licenses that offer free updates, wherein, when doing said updates, the host program orders the module to show an advertisement, being said advertisement related or not with said product.

It is important to emphasize that the disposition offers new multi-dimensional and multi-way interaction with the user, since the advertisement can present any geometrical conformation, not limited to a square or rectangle. In addition, said advertisement could comprise a sound advertisement, which allows the user not to watch anything on screen but to listen the advertisement.

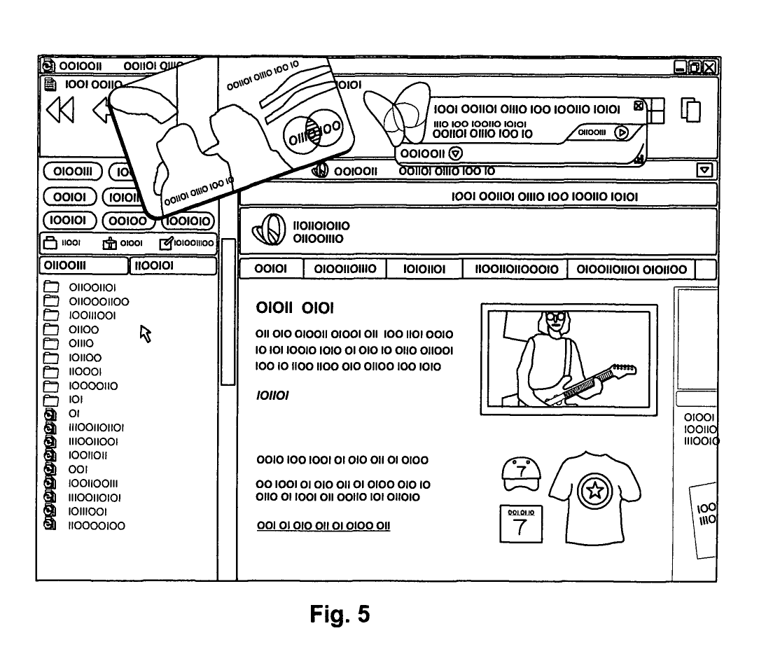

In the examples shown in FIGS. 3 to 5, the way the disposition operates is offering software developers the module, which will be included embedded in their distributed programs. Then, developers are who decide when the advertisement/s will be shown, according to a timer, action done by the user, by subscription, etc.

On the other hand, the audio-visual disposition according to each specific case can operate, be shown, interact or be integrated in different ways. The audio-visual disposition makes possible that different applications share advertising campaigns or keep them completely separated. Additionally, the disposition can manage several advertisements simultaneously.

It is possible to emphasize in addition, that the disposition object of the present invention can report the program the actions the user is doing on the electronic device. In other words, the program could act, for instance, as a result of a “click” or a movement of the mouse pointer done by the user on the advertisement. Furthermore, the disposition is enough operative to successfully obtain information of the user and as a result of this information to show advertisements according to the profile of the user.

It is important to mention that the disposition is developed to show advertisements that are previously stored on some local storage media or to incorporate them remotely via a network, for example Internet. These different operation modalities can be configured by the owner of the host program or can be remotely configured. Alternatively, the audio-visual disposition can be also configured to report answers of the user to corresponding servers in any format available, for example XML Extensible Markup Language) format.

As a result of what have been disclosed, anybody skill in the art could imagine the disposition being used as interactive advertising no matter the navigator program installed on the electronic device. This feature offer alternative ways of advertising, which does not require ineffective and annoying rectangles on screen (pop-ups), giving the advertising designer an effective tool to get user's attention, thus achieving the required effectiveness.

On the other hand, the disposition can also been used to counteract the harmful effect produced as a result of downloading intellectually protected material, since it is widely known that record and cinematographic companies undergo the consequences of Internet files exchange done by means of programs type P2P (Peer to Peer), IRC (International Relay Chat), Waste and the similar, since using the disposition of the present invention users will be allowed to download said files as the usually do, but benefiting companies with profits obtained by means of the advertising generated by files exchanging.

As a result of everything previously explained it is possible to indicate that audiovisual disposition applicable to electronic devices that run operating systems including a graphic user interface object of the present invention offers a new and revolutionary advertising method for the computers world.

It is important to emphasize that the disposition of the present invention can be applied in computerized advertising systems, television projectors or any electronic device capable of reproducing audiovisual signals. Said advertising can comprise, on-line and off-line publicity, instantaneous messages, chatting, internal and external corporative announcing, task helpers and user graphic interfaces.

1. A sound and/or visual signals processing disposition applicable to electronic devices that run operating systems being these devices connected or not connected to a network, wherein the disposition comprises a module which is called by a host program in the electronic device, said module runs at least one routine, defining said at least one routine an interaction zone with the user.

2. The disposition of claim 1, wherein said one module is one of a group integrated by a program unit, a DLL file (dynamic link library), a SO file (shared object), and the similar.

3. The disposition of claim 1, wherein said program is a program that host said module.

4. The disposition of claim 1, wherein said module is executed according to orders instructed to the host program.

5. The disposition of claim 1, wherein said sound and/or visual signals are selectable from a group comprising advertisements, informative notes, instantaneous messages, and the combination of these.

6. The disposition of claim 1, wherein said module is connected to a server in order to update said audio-visual disposition.

7. The disposition of claim 1, wherein said zone of interaction with the computer user is defined by an area inside, outside or inside and outside a window generated by the host program.

8. The disposition of claim 1, obtaining its data from a cache area.

9. The disposition of claim 1, obtaining its data from a remote server.

10. The disposition of claim 1, having information stored in the program that hosts said module.

11. The disposition of claim 1, wherein said disposition is run in transparent manner for the user.

12. The disposition of claim 1, wherein said disposition is executed on any window generated on screen or even in at least one of the z-index levels.

13. The disposition of claim 1, wherein the module information is provided by means of user subscription.

14. A method for executing the disposition of claim 1 comprising the steps of:
a) detecting the capabilities of the operating system wherein said host program is running,
b) verifying if the operating system includes “layered-windows” and/or “alpha channel” attributes or functions,
c) in that case, creating an invisible FORM with an embedded own renderer or a third's renderer,
d) setting layered window and/or alpha channel attributes to the FORM,
e) setting the FORM properties,
f) assigning a multimedia file or a stream of data to the own renderer or to the third's renderer,
g) displaying FORM,
h) starting rendering and running the advertisement,
i) detecting simultaneously the user interaction with said advertisement or rendering messages or commands.

15. The method of claim 14 comprising the steps of:
a) if at step b) “layered-windows attributes” or “alpha channel” attributes are not available, assigning a void variable BMP_TEMP,
b) creating an invisible FORM with an own renderer or with a third's renderer,
c) assigning a value to a variable NRO,
d) creating a region void variables B1 and B2,
e) assigning a multimedia file or a stream of data to the renderer and setting FORM in order to be shaped applying a region variable, showing images and starting running/rendering,
f) verifying if the own renderer or the third's renderer has visualization device context exportation capabilities (DC),
g) in case of having said capabilities, using the exportation capabilities when the renderer.DC variable is needed,
h) if step f) is not fulfilled, then capturing images from form.dc-area when the variable renderer.DC is needed,
i) assigning rendering.DC to variable BMP_TEMP,
j) verifying if variable NRO is equal to 1,
k) if step j) is true, reconfiguring B1 taking as mask the image stored in BMP_TEMP variable without background,
l) verifying if B1 is equal to B2, in that case eliminating data stored in B1, and if being necessary redrawing the FORM and returning to step i),
m) if B1 is not equal to B2, then assigning B1 region to the FORM,
n) eliminating data stored in B2,
o) assigning a value to a variable NRO,
p) if it is necessary, redrawing FORM and returning to step i).

16. The method of claim 14, comprising the following steps:
a) if at step j) variable NRO is not equal to 1, reconfiguring B2 taking as mask the image stored in BMP_TEMP without background;
b) verifying if B1 is equal to B2;
c) if B1 is equal to B2, eliminating data stored in B2;
d) if B1 is not equal to B2, assigning the B2 region to FORM;
e) deleting data stored in B1; and
f) assigning a value to variable NRO;
g) in case of being necessary, redrawing FORM and returning to step i).

17. The method of claim 14, wherein before step a) the disposition reports to a user that said disposition is running.

18. A method for executing the disposition of claim 1, comprising the steps of:
a) starting the module;
b) indicating if distributed rendering services are desired to be used;
c) in that case, sending data configuration, assigning attributes, assigning multimedia files or streams of data and configuring background color to renderizer services;
d) beginning to display the advertisement;
e) if step b) is false, asking if the own renderer or the third's renderer is able to create windows-forms;
f) in that case, enquiring if said feature is desired to be used;
g) if step f) is true, setting properties of FORM.renderizer;
h) assigning a multimedia file or a stream of data to the renderer;
i) sending displaying command to FORM;
j) starting rendering and running advertising;
k) if steps e) and f) are not fulfilled, enquiring if the own renderer or the third's renderer is able to manage transparent backgrounds;
l) in that case, enquiring if that feature is desired to be used;
m) if step l) is affirmative, creating an invisible FORM with the own renderer or of third's renderer;
n) setting FORM properties;
o) assigning a multimedia file or a stream of data to the own renderer or the third's renderer;
p) setting background color value to renderer.transparent and/or alpha channel;
q) displaying the FORM;
r) starting rendering and running it;
s) if step k) or step l) are negative, running another subroutine.

19. The method of claim 18 wherein said another subroutine defines the execution of the disposition.

20. The method of claim 18 comprising the steps of:
a) hiding, simultaneously at step q), events as execution, order, time, etc.;
b) intercepting, simultaneously at step r), the interaction of the user or the commands of the renderer.

21. The method of claim 18 wherein, before step b), the disposition reports the user that said disposition is running.
